(19) United States
(12) Patent Application Publication
(10) Pub. No.: US 2026/0119292 A1
(43) Pub. Date: Apr. 30, 2026

(54) OUTAGE PROJECTION IN CLOUD COMPUTING SYSTEMS

(71) Applicant: Microsoft Technology Licensing, LLC, Redmond, WA (US)

(72) Inventors: George KIM, Redmond, WA (US); Christian LANEY, Bothell, WA (US); Anthony PEREZ, Issaquah, WA (US)

(73) Assignee: Microsoft Technology Licensing, LLC, Redmond, WA (US)

(21) Appl. No.: 18/933,739

(22) Filed: Oct. 31, 2024

(51) Int. Cl. G06F 11/00

(52) U.S. Cl. CPC G06F 11/004; G06F 2201/81

(57) ABSTRACT

Systems and methods to determine a measured risk of a service outage of a service in a cloud computing system. A system determines service dependencies and evaluates parity drift status information associated with the dependencies using an outage projection model (e.g., a machine learning model, heuristic, and/or a combination of models) trained/otherwise operative to identify a pattern of parity drift status information correlated to a historical pattern associated with a past service outage. The system determines an outage risk score and/or level representing the measured risk of a service outage occurring for the service based on the correlation. The system further provides the outage risk score and/or level (e.g., to a remediation and/or deployment orchestration system). In some examples, an alert is provided when the outage risk score and/or level satisfies a threshold (e.g., is highly indicative of a potential service outage) to proactively facilitate prevention of an outage.

### BACKGROUND

A cloud computing system can be used to build, deploy, and manage applications and services. Cloud services of a cloud computing system are oftentimes subject to one or more distributed computing models, where a plurality of cloud resources perform specific functions or provide specific capabilities. Dependencies between a cloud service and various cloud resources exist when the service utilizes the various resources to support the service to function as intended. Thus, the one or more cloud resources are dependencies of the service. A software system deployed in a cloud computing system may include hundreds or thousands of different services and dependencies. Each of these services and dependencies can have multiple versions.

“Parity drift” in the context of cloud computing refers to when a target cloud computing system starts to differ or “drift” from a source or reference cloud computing system (e.g., a last known good version that has been tested and determined to not have any bugs). This can occur due to changes in configuration (e.g., an application programming interface change, a version upgrade), data, or state that are not synchronized between the two systems. Some instances of parity drift can cause inoperability issues and, in some cases, service outages. For instance, an inoperability issue may cause performance of a feature or functionality of the cloud computing system to degrade or become unstable.

It is with respect to these and other considerations that examples have been made. In addition, although relatively specific problems have been discussed, it should be understood that the examples should not be limited to solving the specific problems identified in the background.

### SUMMARY

The technology described herein describes systems and methods to determine a measured risk of a service outage of a service in a cloud computing system. An outage projection system determines dependencies of the service and evaluates parity drift status information associated with the dependencies. In some examples, the outage projection system uses a machine learning model trained to identify a pattern of parity drift status information that is correlated to a historical pattern associated with a past service outage. The system determines an outage risk score and/or level representing the measured risk of a service outage occurring for the service based on the correlation. In other examples, the outage projection uses a heuristic model and/or a combination of models. The system further provides the outage risk score and/or level (e.g., to a remediation system). In some examples, an alert is provided when the outage risk score and/or level satisfies a threshold (e.g., is highly indicative of a potential service outage) to proactively facilitate prevention of an outage. In further examples, a new deployment or a rollback is triggered to prevent an outage. For instance, one or a combination of services can be rolled back to a latest known good state, rolled forward or back to a known state or combination of versions that is stable, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of an example operating environment in which an outage projection system is implemented according to an example;

FIG. 2 depicts an example dependency map of a service of interest according to an example;

FIG. 3 depicts example parity drift status information of a service of interest and its service dependencies according to an example;

FIG. 4A depicts an example outage risk result including ratio-based outage risk scores according to an example;

FIG. 4B depicts an example outage risk result including ratio-based outage risk scores and indications of potential outage risk levels according to an example;

FIG. 5 depicts a flow diagram depicting a first example method of determining a measured risk of a potential occurrence of a service outage according to an example; and

FIG. 6 is a block diagram illustrating example physical components of a computing device with which examples of the disclosure may be practiced.

### DETAILED DESCRIPTION

Implementations of the present disclosure use an outage projection system to determine a measured risk (potential) of a service outage of a service of interest in a cloud computing system according to examples. More specifically, the outage projection system determines dependencies of the service of interest and then evaluates parity drift status information associated with service dependencies to identify a pattern of parity drift status information that correlates to a historical pattern of parity drift status information associated with a past outage. In some examples, a machine learning (ML) model is used to determine and output an outage risk score that represents the measured risk of a service outage occurring for the service of interest based on the correlation. In further examples, the outage projection system determines a potential outage risk level based on the outage risk score and provides, as output, an indication of the potential outage risk level. In some implementations, the outage risk score and the potential outage risk level are measured across a group of computing resources. For instance, an inquiry may be received for a potential outage risk score and/or level of a physical grouping of cloud resources.

In yet further examples, an alert is provided in association with the output when the outage risk score and/or potential outage risk level satisfies an upper threshold (e.g., is highly indicative of a potential service outage). For instance, the outage projection system proactively facilitates prevention of a service outage of the service of interest in the cloud computing system by determining the measured risk of a potential service outage and providing an output that indicates the measured risk. Implementations of the present disclosure provide benefits, such as improving reliability of the service of interest. For instance, by projecting and proactively preventing outages, downtime and disruptions are minimized, thereby enhancing the reliability of the service of interest.

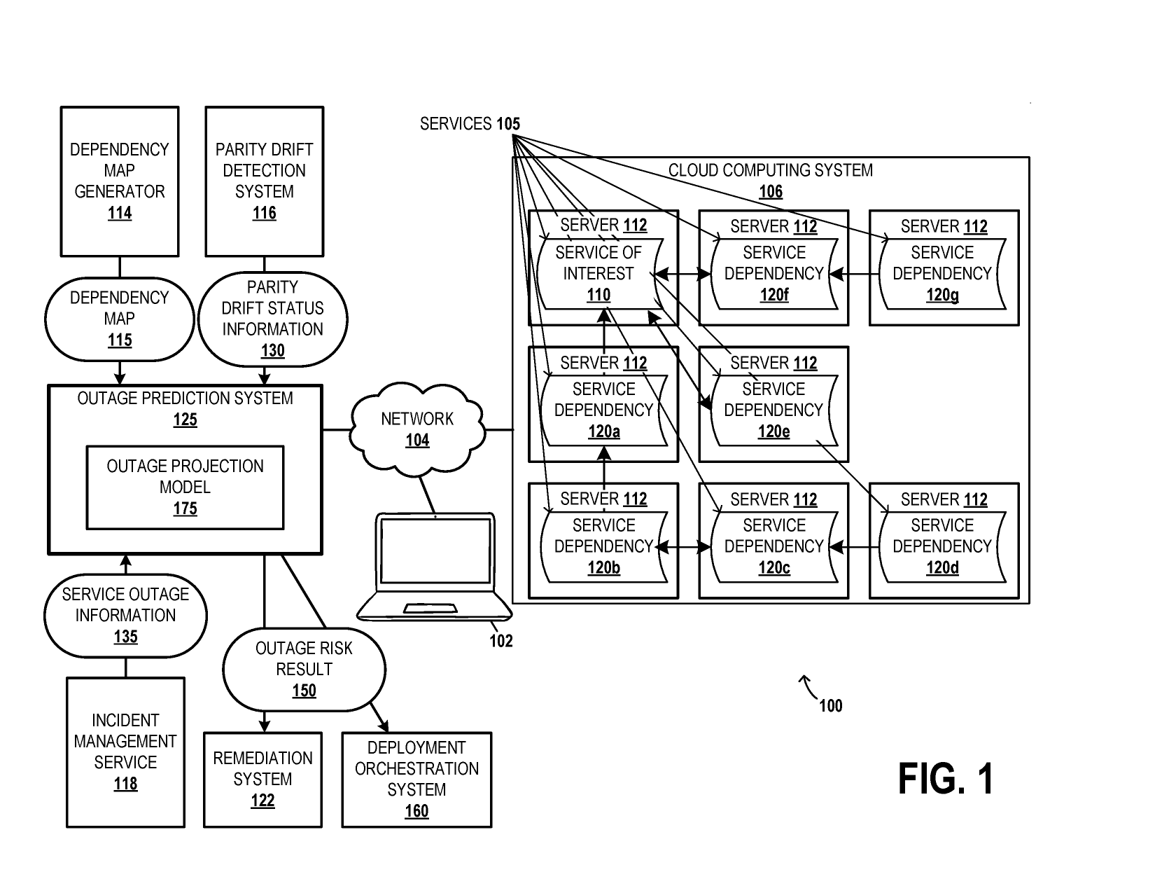

FIG. 1 is a block diagram illustrating an overview of an example operating environment 100 in which parity drift related outage projection is implemented according to an example. The operating environment 100 includes a cloud computing system 106 including one or more hardware and/or software components. In aspects, the cloud computing system 106 includes or provides access to service(s) 105 to user devices 102 (e.g., personal computers (PCs), mobile devices (smartphones, tablets, laptops, personal digital assistants (PDAs)), wearable devices (smart watches, smart eyewear, fitness trackers, smart clothing, body-mounted devices, head-mounted displays), media devices, gaming consoles or devices, Internet of Things (IoT) devices, etc.). For instance, components are subject to various distributed computing models/services, such as Infrastructure as a Service (IaaS), Platform as a Service (PaaS), Software as a Service (SaaS), and Functions as a Service (FaaS). Although FIG. 1 is depicted as including a particular combination of computing environments and devices, the scale and structure of systems such as operating environment 100 and/or cloud computing system 106 may vary and may include additional or fewer components than those described in FIG. 1. As one example, the operating environment 100 may include multiple cloud computing systems 106. As yet another example, one or more user device(s) 102 may include or locally access one or more services 105.

In examples, the services 105 are provisioned on managed servers 112. In some examples, the services 105 are provisioned on virtual machines (VMs) implemented on the managed servers 112 using a containerized architecture or hypervisor architecture. When an application is executed in such virtualized environments, various services 105 of the distributed computing system can be invoked by applications, libraries, or binaries executed in the VMs, a container engine or hypervisor, and/or by a host operating system in response to requests from software components in the VMs. In some examples, for each service 105, a corresponding service instance is instantiated on the servers 112 in response to the requests by the VMs. The service instances may communicate with each other and other service instances within the operating environment 100 over computer networks 104. In some examples, a service 105 includes a plurality of service instances executed on servers 112 across one or more cloud computing systems 106. In some implementations of a distributed cloud computing system 106, millions of servers 112 may be provided, and billions of requests per hour may flow between service instances. Further, the servers 112 may be located in data centers located in different geographic regions. Each geographic region includes its own set of servers 112 and infrastructure to handle the operations of the service instance. In examples, the larger and more distributed the cloud computing system 106, the more complex it becomes to determine when various services 105 may be out of parity. For instance, parity drive is a natural occurrence where there may be hundreds, thousands, or more concurrent ongoing changes occurring at any given point of time in a cloud computing system 106 (e.g., reference and target cloud computing system 106). In some implementations, services 105 are tested with a specific combination of dependency versions but may not be tested with all possible deployed permutations.

According to an example implementation, the operating environment 100 includes an outage projection system 125 that determines risk of a potential service outage of a service of interest 110 of a cloud computing system 106. The term “service of interest” 110 is used herein to describe a service 105 that is being evaluated by the outage projection system 125 for determining a measure of a potential occurrence of a service outage. In examples, the outage projection system 125 evaluates a service of interest 110 and provides an outage risk result 150 when triggered. In various implementations, the outage projection system 125 is triggered by a scheduler or timer, automatically as part of an onboarding process or update of the service of interest 110, when input is received (e.g., from a dependency map generator 114, a parity drift detection system 116, and/or an incident management service 118), based on receiving user input (e.g., via an HTTP trigger-based execution), or via another method. In examples, the outage projection system 125 determines the measurement of a potential occurrence of a service outage based on an identified pattern of parity drift status of one or more services 105 in the cloud computing system 106 that have a dependency relationship with the service of interest 110. In some examples, processing a payload by the service of interest 110 includes leveraging (e.g., depending on) functionality of one or more other services 105 to perform or enhance performance of an operation. The term “service dependency” 120a-120g (collectively, service dependency 120) is used herein to describe a service 105 upon which another service 105 depends.

Parity drift status refers to a comparison between a reference cloud computing system 106 and a target cloud computing system 106 indicating whether the target cloud computing system 106 is operating at a same or different level as the reference cloud computing system 106. The reference cloud computing system 106 includes a last known good version of a service 105 that has been tested and determined to not have any bugs. In some examples, the reference cloud computing system 106 represents the service 105 at a previous time, a different instance of the service 105, or another service 105 similar to the service 105 (e.g., performs comparable functions, has comparable configurations, or has similar dependencies). In examples, parity drift status includes an indication of detected parity drift (e.g., when a service 105 starts to differ or “drift” from a source (the reference cloud computing system 106)). Maintaining parity across separate cloud computing systems 106 is difficult because of the immense size and complexities of cloud computing systems 106. Further, services 105 largely deploy and replicate independently from each other and on irregular schedules.

The cloud computing system 106 depicted in FIG. 1 includes an example service of interest 110 and multiple example service dependencies 120. In some examples, a service dependency 120 is a direct dependency of the service of interest 110. In other examples, a service dependency 120 is an indirect dependency of the service of interest 110. For instance, service dependencies 120a, 120e, and 120f are direct dependencies of the service of interest 110, while service dependencies 120b, 120c, 120d, 120g, and 120h are indirect dependencies of the service of interest 110. By being dependencies of the service of interest 110, the service dependencies 120 provide functionality to the service of interest 110 to enable the service of interest 110 to perform tasks (e.g., retrieve data, store data, schedule an event). As one example, a network monitoring service 105 (e.g., a service of interest 110) may rely on an event analysis service 105 (e.g., a service dependency 120) to classify network activity detected by the network monitoring service 105. In this example, the network monitoring service 105 may invoke (e.g., call) the event analysis service 105 in response to detecting potentially anomalous network activity. The event analysis service 105 may evaluate the network activity and provide results of the evaluation to the network monitoring service 105. As another example, a content recommendation service 105 (e.g., a service of interest 110) designed to provide users with personalized content recommendations may depend on a large language model (LLM) as a service dependency 120 to analyze the user’s preferences and browsing history and generate insights about the user’s interests. Other types of services of interest 110 and service dependencies 120 are possible and are within the scope of the present disclosure. In some examples, a service dependency 120 is both a dependency of and dependent on one or more other service dependencies 120 and/or the service of interest 110. For example, service dependencies 120e and 120f are dependencies of the service of interest 110, and further, the service of interest 110 is a dependency of service dependencies 120e and 120f. As a dependency of the service dependencies 120e and 120f, the service of interest 110 provides functionality that enables the service dependencies 120e and 120f to perform their respective tasks. The service of interest 110 may be associated with any number of direct or indirect service dependencies 120 and each service dependency 120 may be dependent on any number of other service dependencies 120, services 105, or services of interest 110.

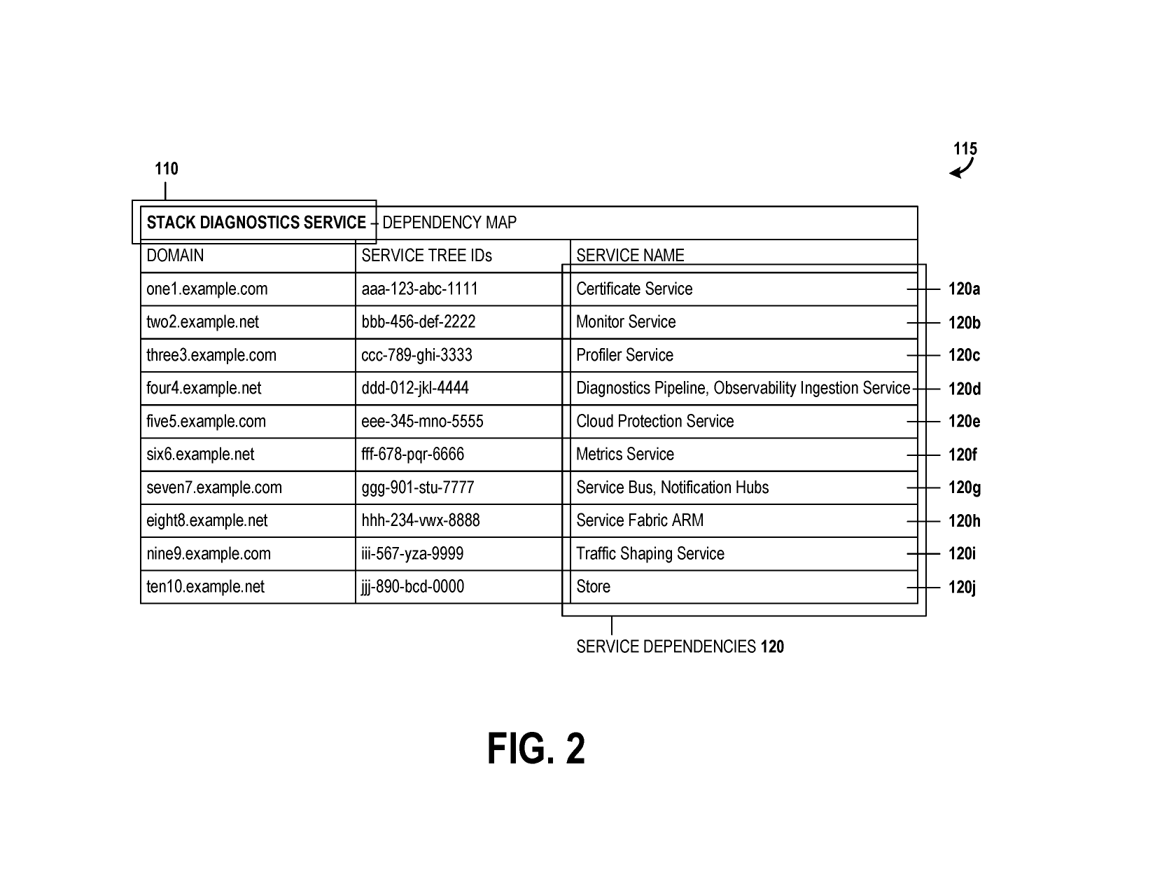

According to an aspect, the outage projection system 125 includes or is in communication with a dependency map generator 114. The dependency map generator 114 generates and provides service-to-service dependency maps 115 to the outage projection system 125. A service-to-service dependency map 115 is a representation of dependency relationships between a service of interest 110 and other services 105 in one or more cloud computing systems 106. In some examples, the dependency map generator 114 generates the dependency map 115 by analyzing Domain Naming Service (DNS) logs and fleet management system logs corresponding to a group of cloud computing systems 106 that are managed together. For instance, the fleet of cloud computing systems 106 are monitored for potential outages by the outage projection system 125. DNS logs include records of network requests made by services 105. By analyzing the DNS logs, the dependency map generator 114 can identify which services 105 are communicating with each other. The fleet management system logs include information about the state of the cloud computing system 106, including which services 105 are running on which machines (e.g., servers 112), the Internet Protocol (IP) addresses of the services 105, etc. By analyzing the fleet management system logs, the dependency map generator 114 can identify which services 105 are associated with specific container identifiers and IP addresses. In some implementations, the dependency map generator 114 includes a computing system configured to perform a method to generate a dependency map 115, such as a computing system described in U.S. Patent No. US11962565B1 to Pathak et al., which is hereby incorporated by reference in its entirety. For instance, and as depicted in FIG. 2, an example dependency map 115 is shown including a list of service dependencies 120a-120j of a service of interest 110 (e.g., “stack diagnostics service”).

According to an aspect, and with reference again to FIG. 1, the outage projection system 125 further includes or is in communication with a parity drift detection system 116 that monitors the fleet of cloud computing systems 106 for parity drift. In some implementations, the parity drift detection system 116 includes a computing system configured perform a method to determine parity drift status and detect instances of parity drift, such as a computing system described in U.S. Patent No. US11843501B2 to Perez et al., which is hereby incorporated by reference in its entirety.

In some examples, the parity drift detection system 116 uses various parity dimensions to measure and score differences between a reference cloud computing system and a cloud computing system 106 to determine instances of parity drift. Example parity dimensions include a distance value (e.g., between version numbers), a freshness value (e.g., a time since a last deployment on the cloud computing system 106), a deployment time value (e.g., a number of deployments in the reference system since the last corresponding deployment in the cloud computing system 106, an age value (e.g., a time since the reference cloud computing system was updated from a version identified in the cloud computing system 106), etc.

In some examples, the parity drift detection system 116 further determines a parity grade based on parity scores of one or more parity dimensions for a service 105. The parity drift detection system 116 can use various types of grading systems to indicate parity grades. For example, the parity drift detection system 116 can employ a red, yellow, green grading model that represents severity of parity drift in a cloud computing system 106 (e.g., green indicating minor (or no) parity drift, yellow indicating moderate parity drift, and red indicating significant parity drift). The parity scores are determined by comparing reference data to target data. In some instances, the parity drift detection system 116 uses a number scale (e.g., 1-10, 1-100, etc.), a letter-grade, or other type of grading system. According to examples, the parity drift detection system 116 provides parity drift status information 130 (e.g., parity grades, parity scores, and/or parity dimensions) associated with the service of interest 110 and each of the service dependencies 120 to the outage projection system 125.

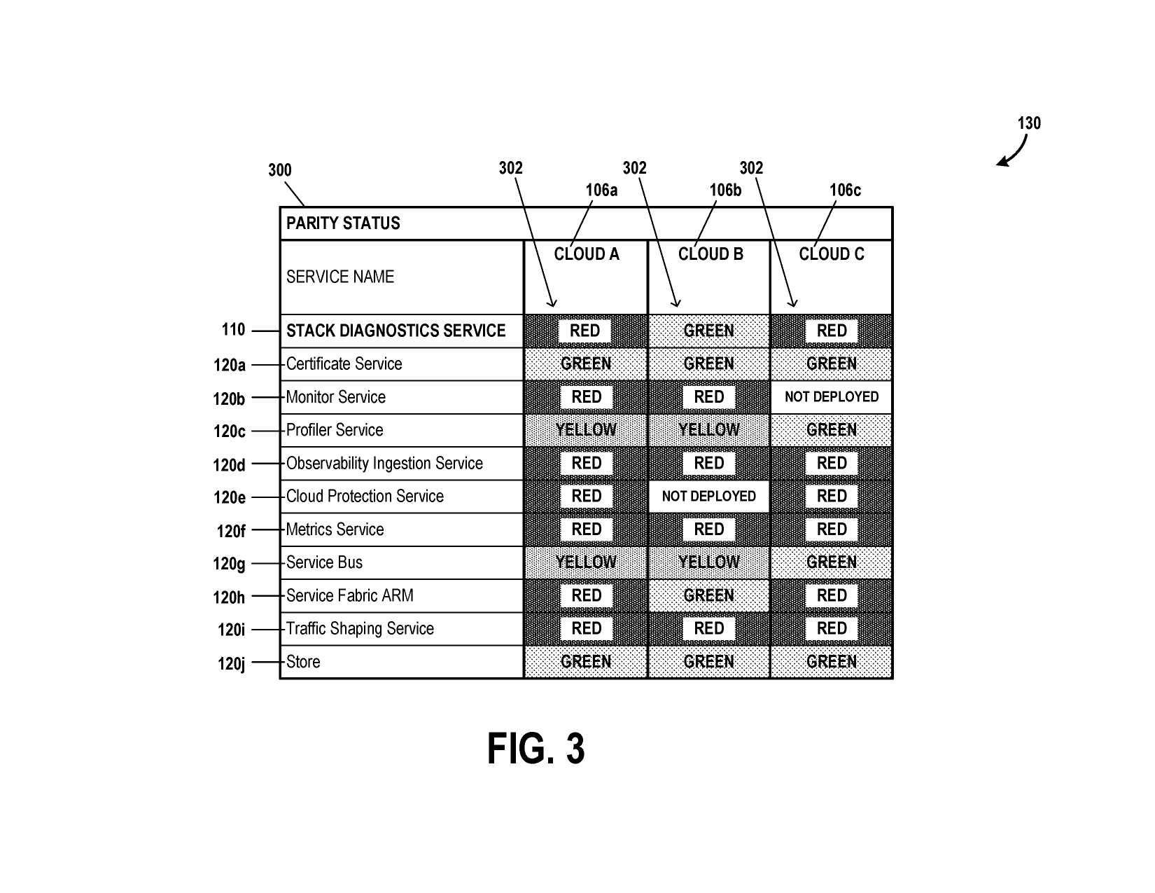

For instance, and with reference to FIG. 3, an example parity drift report 300 is depicted including parity drift status information 130 provided by the parity drift detection system 116. The example parity drift report 300 includes a list of the service dependencies 120a-120j of the service of interest 110, a list of a plurality of cloud computing systems 106a-106c in which the service of interest 110 and its service dependencies 120a-120j operate, and an indication of a parity grade 302 for the service of interest 110 and each service dependency 120 for each cloud computing system 106a-106c. As an example, the first cloud computing system 106a may be associated with a first geographic region, the second cloud computing system 106b may be associated with a second geographic region, and the third cloud computing system 106c may be associated with a third geographic region.

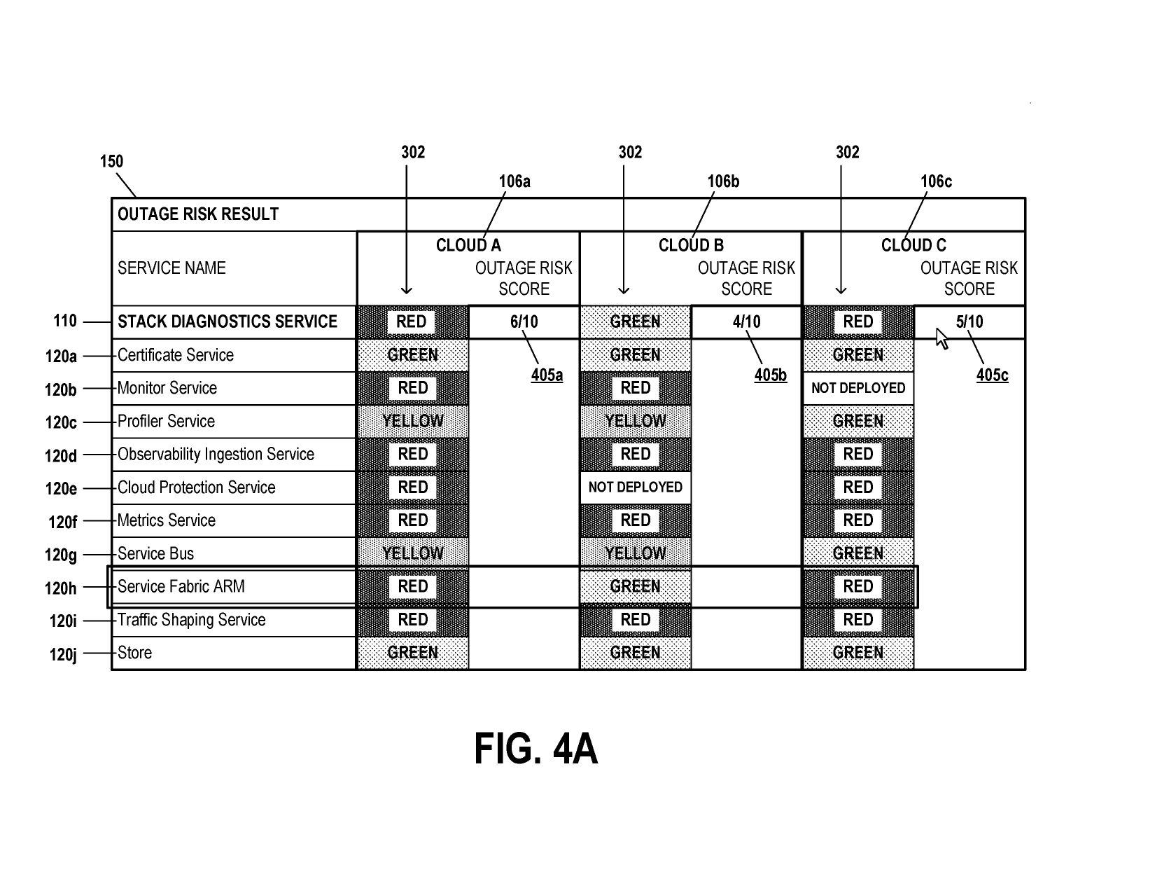

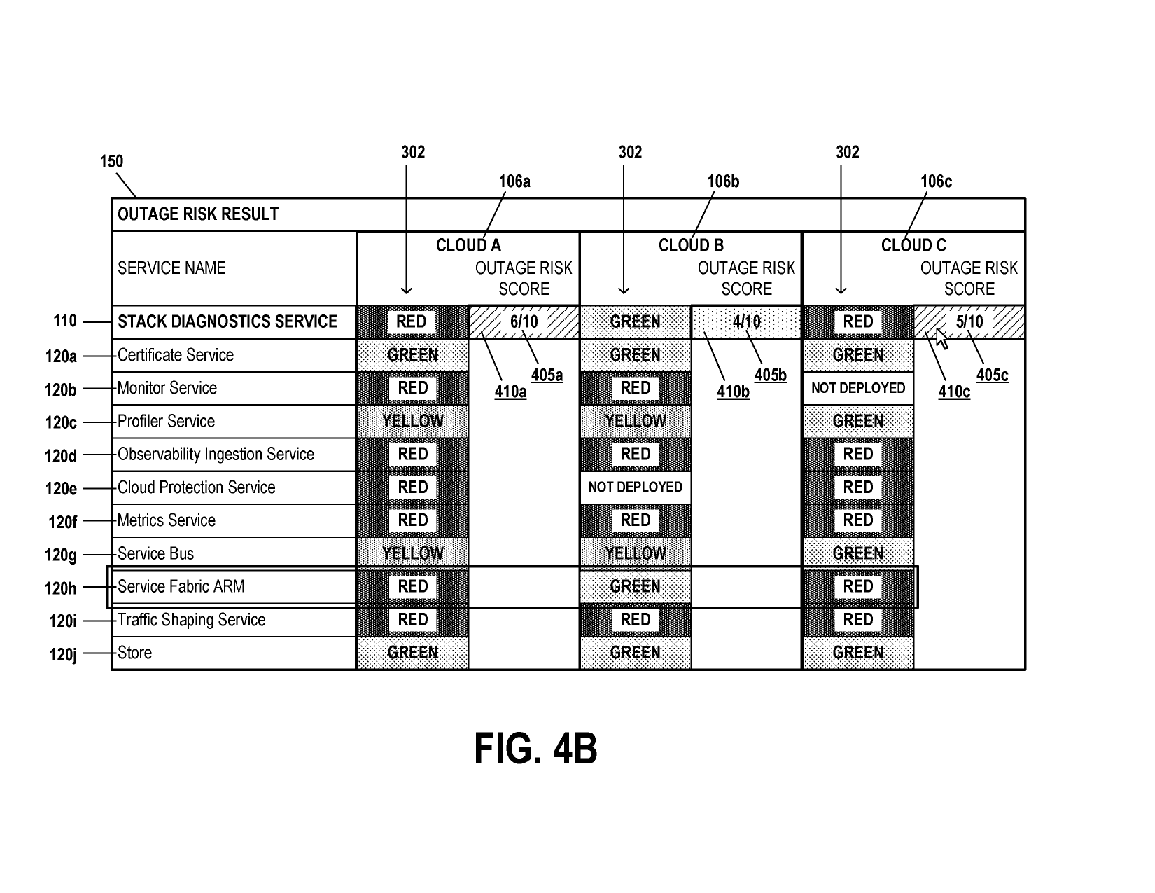

In some implementations, the outage projection system 125 determines one or more outage risk scores when determining an example outage risk result 150 for assessing a measure of a potential occurrence of an outage of a service of interest 110. In some examples, the one or more outage risk scores include a ratio-based outage risk score that represents a measurement of a ratio of service dependencies 120 of a service of interest 110 that are out of parity in a cloud computing system 106. For instance, and as depicted in FIG. 4A, an example outage risk result 150 includes ratio-based outage risk scores 405a-405c (collectively, ratio-based outage risk scores 405) for corresponding cloud computing systems 106a-106c, where each ratio-based outage risk score 405 represents a ratio between the number of the service dependencies 120 in the cloud computing system 106 that are out of parity and the number of service dependencies 120 of the service of interest 110.

As an example, the service of interest 110 has ten service dependencies 120a-120j and is indicated as being out of parity in a first cloud computing system 106a and a third cloud computing system 106c. A first example ratio-based outage risk score 405a for the service of interest 110 is shown as 6/10, indicating that six of the ten service dependencies 120 in the first cloud computing system 106a (e.g., cloud “A”) are determined to be out of parity. A second ratio-based outage risk score 405b is shown as 4/10, indicating that four of the ten service dependencies 120 in the second cloud computing system 106b are determined to be out of parity. A third ratio-based outage risk score 405c is shown as 5/10, indicating that five of the ten service dependencies 120 in the third cloud computing system 106c are determined to be out of parity. The ratio-based outage risk scores 405 provide insight into a level of parity drift that exists in association with the service of interest 110 and its service dependencies 120.

In some examples, the one or more outage risk scores additionally or alternatively include an affinity-based outage risk score that represents a measured risk (potential) of a service outage occurring for the service of interest 110 in a cloud computing system 106 based on a correlation of a pattern of parity drift status(es) of one or more of the service dependencies 120 of the service of interest 110 with a historical pattern associated with past outages. According to an example, a parity drift status pattern includes one or a combination of parity drift status information 130 (e.g., parity grades 302, parity scores, and/or parity dimensions) that corresponds to one or more past outage instances of the service of interest 110.

According to an aspect, and as depicted in FIG. 1, the outage projection system 125 further includes or is in communication with an incident management service 118. In some examples, the incident management service 118 is configured as a trouble ticketing system or service help desk portal that records and provides records of detected outages in a cloud computing system 106. In some examples, a record of a detected outage is provided to one or more remediation systems 122 to resolve. The record includes outage information 135 about the detected service outage.

In examples, the incident management service 118 provides service outage information 135 to the outage projection system 125. In further examples, the outage information 135 includes information about outages from interoperability issues due to parity drift. Example service outage information 135 includes an outage identifier, a name of the service 105 detected as experiencing the outage (e.g., service X, where service X is a dependent service), and a severity level of the outage. Severity levels represent the degree to which a detected service outage has impacted the performance of a service 105. For instance, a first severity level may designate a slight impact to the service 105 (e.g., a small amount of the service’s functionality is impacted or unavailable), a second severity level may designate a moderate impact to the service 105 (e.g., a moderate amount of the service’s functionality is impacted or unavailable), and a third severity level may designate a severe impact to the service 105 (e.g., a substantial amount or all of the service’s functionality is impacted or unavailable). In some examples a record further includes outage information related to service dependencies 120 of a service 105 experiencing an outage. In further examples, the service dependency outage information includes metrics of the affected service 105 related to the detected outage. For instance, the metrics represent anomalous activity that is indicative of an outage (e.g., outlier data points, unexpected trends, elevated resource usage).

In some implementations, the outage projection system 125 includes or is in communication with an outage projection model 175. In some examples, the outage projection model 175 is an ML model that is used to determine a risk level representing a potential occurrence of a service outage of a service of interest 110 in a cloud computing system 106. Time series (e.g., AutoRegressive Integrated Moving Average (ARIMA), Long Short-Term Memory (LSTM)), regression (e.g., linear, logistic), tree-based (e.g., Random Forest, Gradient Boosting), neural networks (e.g., Multilayer Perceptrons (MLPs), autoencoders), anomaly detection (Isolation Forest), and/or other types of ML models can be used to determine the risk level. In examples, the outage projection model 175 is built, trained, and updated using historical parity drift status information 130 associated with the service of interest 110 and the service of interest’s service dependencies 120 and service outage information 135 associated with the service of interest 110. The outage projection model 175 is built, trained, and updated to identify features that affect the likelihood of an outage of the service of interest 110 occurring. In other implementations, the outage projection model 175 is a heuristic model that follows a pre-defined rule set. In some examples, the outage projection model 175 is implemented as a singular “global” model that is used across a plurality of different services 105. In other examples, the outage projection model 175 is implemented as per-service models that are tailored to specialize in a particular service 105 (e.g., service of interest 110) and its service dependencies 120. When analyzing a service of interest 110, indicators are aggregated from one or a combination of the global outage projection model 175 and the service-specific outage projection model 175. For instance, the global outage projection model 175 is better suited for more 'generic' indicators such as cross-service and errors in indirect service dependencies 120, while the service-specific outage projection model 175 offers higher accuracy around nuances of the service of interest 110 and its direct dependencies.

In an example implementation, the identified features include a pattern of parity drift status information 130 associated with one or more of the service dependencies 120 of the service of interest 110. According to an example, parity drift status patterns include one or a combination of parity drift status information 130 (e.g., parity grades, parity scores, and/or parity dimensions) that corresponds to one or more past outage instances of the service of interest 110. Weights are applied to parity drift status patterns based on a number and/or severity level of previous (historical) outages. For instance, higher weights may be applied to patterns that are associated with a higher number of outages, outages that last an extended period of time, outages that affect higher-priority services of interest 110 or users, etc.

In some examples, the outage projection system 125 provides, as input to the outage projection model 175, parity drift status information 130 of a service of interest 110 and identified service dependencies 120 of the service of interest 110 and receives, as output, an affinity-based outage risk score corresponding to a determined measurement of risk of occurrence of an outage of the service of interest 110 in a corresponding cloud computing system 106. For instance, if a current pattern of parity drift status information 130 matches a historical pattern that has frequently led to outages or has caused significant outages of the service of interest 110 in the past, the affinity-based outage risk score may be higher.

As an example, the outage projection model 175 may have been trained (and/or include heuristic rules defined) using historical data of an association between a particular service dependency 120 being out of parity and a plurality of past outages. For instance, the particular service dependency 120 may be a resource manager template used to define the configuration and infrastructure for the cloud computing system 106, where the particular service dependency’s version not being in parity may adversely affect the service of interest’s ability to upgrade for new deployment or to recover the service of interest 110. Thus, when the particular service dependency 120 is identified as out of parity, the outage projection model 175 may determine a higher affinity-based outage risk score (e.g., than when another service dependency 120 or combination of service dependencies 120 are out of parity).

As another example, two particular service dependencies 120 may be out of parity. Historical data may reveal that, individually, neither of the two particular service dependencies 120 being out of parity is highly indicative of an outage. However, the outage projection model 175 may have learned from the historical data that an outage of the service of interest 110 is more likely when both of the two particular service dependencies 120 are out of parity at the same time. Therefore, in this case, the outage projection model 175 projects a higher affinity-based outage risk score (e.g., than when another service dependency 120 or combination of service dependencies 120 are out of parity).

In some implementations, the outage projection system 125 further determines a risk level for a potential outage of the service of interest 110 based on the affinity-based outage risk score determined for a cloud computing system 106. For instance, a potential outage risk level represents likelihood of an outage occurring due to an inoperability issue, where the potential outage risk level increases as a corresponding affinity-based outage risk score increases. The outage projection system 125 can use various types of grading systems to indicate or report potential outage risk levels. In some examples, and as depicted in FIG. 4B, the outage risk result 150 additionally or alternatively includes an indicator of a potential outage risk level (potential outage risk level indicator 410a-410c (collectively potential outage risk level indicator 410)) determined for the service of interest 110, where the outage projection system 125 can employ a text, number, or color/shading grading model for representing the indication (e.g., “low,” 1-3, or green indicating a lower likelihood of an outage; “moderate,” 4-6, or yellow indicating a moderate likelihood of an outage; and “high,” 7-10, or red indicating a higher likelihood of an outage).

In some implementations, the outage projection system 125 provides the outage risk result 150 or an indication of the outage risk result 150 as output. For instance, the outage risk result 150 is provided to one or more downstream systems (e.g., a remediation system 122) and/or one or more users to proactively facilitate prevention of a service outage of the service of interest 110 in a cloud computing system 106. In some examples, the outage risk result 150 is provided based on the determined outage risk score and/or level (e.g., when the ratio-based outage risk score 405 and/or affinity-based outage risk score satisfies an upper threshold). In further examples, the outage risk result 150 is presented to a user via a user interface of a user device 102.

In some implementations, the outage projection system 125 provides an alert indicating an instance of parity drift at a service dependency 120 in association with a determined outage risk score and/or level. For instance, the outage projection system 125 provides an alert to a user device 102 associated with the service dependency 120 that is out of parity (e.g., based on parity drift status information 130) and negatively affects the outage risk score and/or level of the service of interest 110. In some examples, the alert is in the form of an email, text message, etc. In one example, the email, text message, etc., includes a response link that a recipient can select to indicate a change in parity drift status of the service dependency 120.

In other implementations, the outage projection system 125 further receives an indication of an update of parity drift status of the service dependency 120. In some examples, the outage projection system 125 monitors the parity drift status of the service dependency 120 and identifies when parity drift status information 130 of the service dependency 120 indicates the service dependency 120 is in parity or otherwise causes the outage risk score and/or level of the service of interest 110 to lower (e.g., reduce the risk of a service outage of the service of interest 110). For instance, the outage projection system 125 polls the parity drift detection system 116 for updates to the parity drift status of the service dependency 120. In other examples, the outage projection system 125 receives a communication (e.g., email or other message) of the update of parity drift status of the service dependency 120. For instance, the communication may be sent by an administrative user or automatically by a user device 102.

In some implementations, when the outage projection system 125 receives an indication of an update of parity drift status of the service dependency 120 that causes the outage risk score and/or level of the service of interest 110 to satisfy a lower threshold (e.g., where the lower threshold indicates a lower risk of a service outage), the outage projection system 125 triggers a configuration change (e.g., an application programming interface change, a version upgrade, a version rollback, a service migration from one device or platform to another) to occur. For instance, triggering of the configuration change is dependent on the outage risk result 150 satisfying the lower threshold. In some examples, a new deployment or a rollback is triggered to avoid an outage. For instance, the service of interest 110 and/or one or a combination of service dependencies 120 can be rolled back to a latest known good (LKG) state, rolled forward or back to a known state or combination of versions that is stable, etc. In some examples, the outage projection system 125 is in communication with a deployment orchestration system 160 and provides outage risk results 150 to the deployment orchestration system 160. The deployment orchestration system 160 schedules deployments based on various variables, such as deployment priority (e.g., low priority indicating normal deployment versus high priority indicating a hotfix/mitigation), impact assessments (e.g., attempts to batch impactful deployments together to reduce node downtime), preferred maintenance windows (e.g., whitelisted or blacklisted timeframes), etc. In some examples, the deployment orchestration system 160 uses received outage risk results 150 to prioritize deployments for services 105 that are determined to be at a higher risk of parity-related issues. In further implementations, a configuration change is blocked or otherwise prevented until the indication of the update of the parity drift status of the service dependency 120 is received.

In yet further examples, the ratio-based outage risk scores 405 and/or potential outage risk level indicators 410 are selectable via the user interface and include a link to additional information. For instance, selection of a ratio-based outage risk score 405 and/or potential outage risk level indicator 410 provides a list of parity drift status information 130 about the associated service dependencies 120. In some implementations, selecting a ratio-based outage risk score 405 and/or potential outage risk level indicator 410 provides an indication of how the service of interest 110 may be affected due to a potential outage. In examples, the indication of how the service of interest 110 may be affected is based on service outage information 135 about past detected outages of the service of interest 110, where the past detected outages have a pattern of parity drift status information 130 that is identified as similar to parity drift status information 130 associated with one or a combination of service dependencies 120 of the service of interest 110.

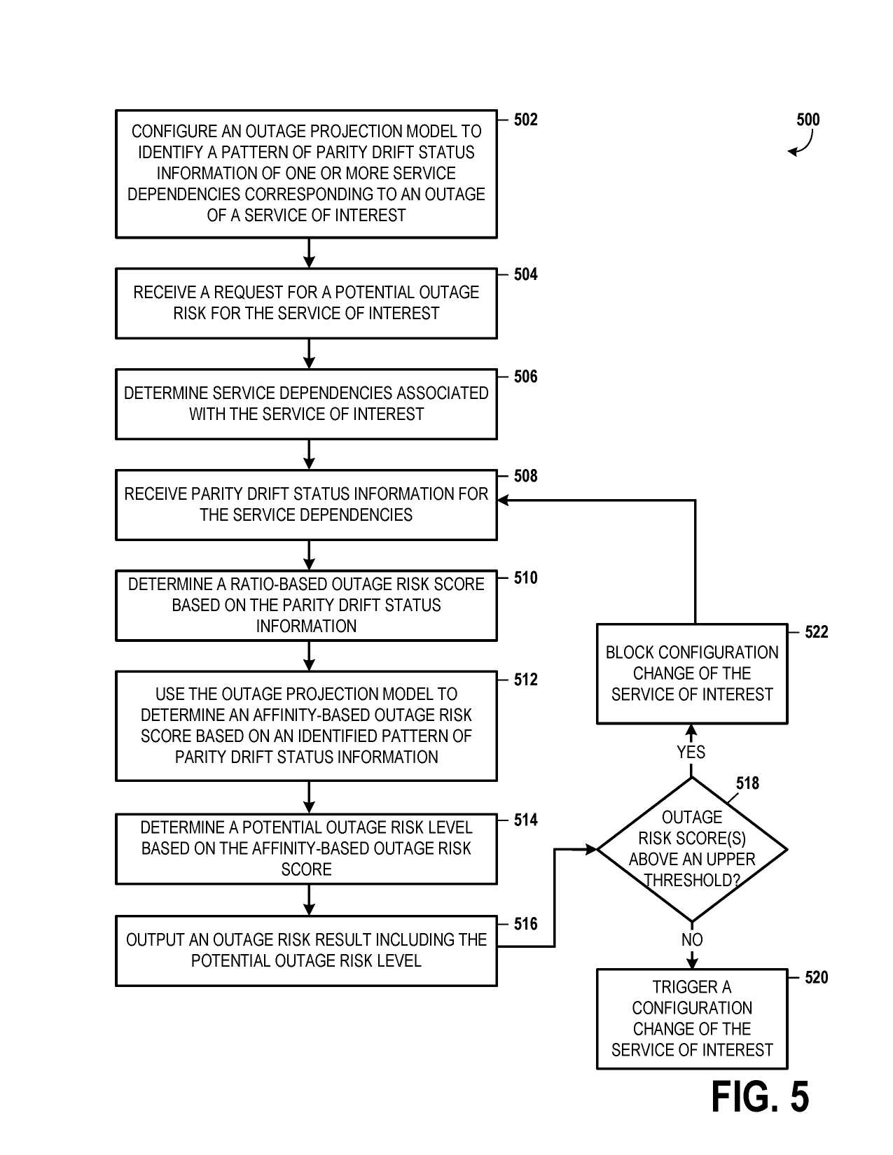

With reference now to FIG. 5, a flow diagram of an example method 500 for determining a risk level of a potential service outage of a service of interest 110 in a cloud computing system 106 is depicted. At operation 502, an outage projection model 175 is configured to identify a pattern of parity drift status information 130 of one or more service dependencies 120 of the service of interest 110 that corresponds to historical outages of the service of interest 110. In some examples, the outage projection model 175 is an ML model trained using a training set of service outage information 135. For example, the training set of service outage information 135 includes records of past detected outages of the service of interest 110 and parity drift status information 130 (e.g., parity grades, parity scores, and/or parity dimensions) associated with the service of interest 110 and each of the service dependencies 120 of the service of interest 110. The outage projection model 175 is trained to identify a pattern of parity drift status information 130 that corresponds to a past detected outage to identify similar patterns of parity drift status information 130 to project a risk level for a potential subsequent outage of the service of interest 110. The training can include supervised learning, semi-supervised learning, unsupervised learning, reinforcement learning, and/or the like, including combinations and/or multiples thereof. In other examples, a rule set and thresholds are defined for which a heuristic-based outage projection model 175 is established to follow to project a risk level for a potential outage of the service of interest 110.

At operation 504, a request is received by the outage projection system 125 or the outage projection system 125 is otherwise triggered to determine a risk level for a potential outage of the service of interest 110 in the cloud computing system 106. In some implementations, the outage projection system 125 is triggered by a scheduler or timer, by a configuration change (e.g., an onboarding process of or update to the service of interest 110), when input is received (e.g., from a dependency map generator 114, a parity drift detection system 116, and/or an incident management service 118), when user input (e.g., via an HTTP trigger-based execution) is received, or via another method. In examples, the request/trigger includes a reference to the service of interest 110. In further examples, the request/trigger includes a reference to the cloud computing system 106.

At operation 506, a determination is made as to which services 105 have a dependency relationship with the service of interest 110. In some implementations, the service dependencies 120 are determined using a dependency map 115. In some examples, the outage projection system 125 requests the dependency map 115 from the dependency map generator 114. In other examples, the dependency map 115 is automatically provided to the outage projection system 125 (e.g., as part of the request/trigger).

At operation 508, parity drift status information 130 for the service of interest 110 and the determined service dependencies 120 is received. In some examples, the outage projection system 125 requests the parity drift status information 130 from the parity drift detection system 116. In other examples, the parity drift status information 130 is automatically provided to the outage projection system 125 (e.g., as part of the request/trigger).

At operation 510, a ratio-based outage risk score 405 for the service of interest 110 is determined based on the parity drift status information 130. For instance, the outage projection system 125 determines a ratio between the number of the service dependencies 120 in the cloud computing system 106 that are out of parity in the cloud computing system 106.

At operation 512, the outage projection system 125 uses the outage projection model 175 to determine an affinity-based outage projection score for the service of interest 110 based on the parity drift status information 130. In some examples, the outage projection model 175 identifies one or more patterns in the parity drift status information 130 that can be correlated to one or more patterns in training data corresponding to previous service outages and generates an affinity-based outage projection score based on the identified pattern(s). In some examples, weights are applied to correlated patterns based on a number and/or severity level of previous (historical) outages, where higher weights may be applied to patterns that are associated with a higher number of outages, outages that last an extended period of time, outages that affect higher-priority services of interest 110 or users, etc. The affinity-based outage projection score represents a measured risk (potential) of a service outage occurring for the service of interest 110 in the cloud computing system 106 based on the correlation(s).

At operation 514, a potential outage risk level is determined for the service of interest 110 for the cloud computing system 106 based on the affinity-based outage projection score. Various types of grading systems may be used to represent a scale of potential outage risk levels.

At operation 516, an outage risk result 150 is generated and provided as an output. In some implementations, the outage risk result 150 includes the ratio-based outage risk score 405. In further implementations, the outage risk result 150 additionally or alternatively includes the affinity-based outage risk score. In yet further implementations, the outage risk result 150 additionally or alternatively includes a potential outage risk level indicator 410 representing the determined potential outage risk level. According to examples, the outage risk result 150 is used to communicate the measured risk of a service outage occurring for the service of interest 110 in the cloud computing system 106. In some examples, the outage risk result 150 is provided when one or a combination of the ratio-based outage risk score 405, the affinity-based outage risk score, and/or the potential outage risk level indicator 410 satisfies an upper threshold. In further examples, one or more of the ratio-based outage risk score 405, the affinity-based outage risk score, and/or the potential outage risk level indicator 410 are selectable, where a selection causes associated parity drift status information 130 and/or outage information 135 to be provided. The outage risk result 150, parity drift status information 130, and/or outage information 135 is provided to proactively facilitate prevention of a service outage of the service of interest 110 in the cloud computing system 106.

In some implementations, the method 500 proceeds to decision operation 518, where a determination is made as to whether the ratio-based outage risk score 405, the ratio-based outage risk score 405, the affinity-based outage risk score, and/or the potential outage risk level indicator 410 satisfies an upper threshold. For instance, when the upper level is not satisfied (e.g., indicating a lower risk of a potential service outage), the method 500 proceeds to operation 520, where the configuration change of the service of interest 110 that triggered the outage projection system 125 at operation 504 is triggered or otherwise authorized to proceed.

In some implementations, when the ratio-based outage risk score 405, the affinity-based outage risk score, and/or the potential outage risk level indicator 410 satisfies the upper threshold (e.g., indicating a higher risk of a potential service outage), the method 500 proceeds to operation 522, where the configuration change of the service of interest 110 that triggered the outage projection system 125 at operation 504 is blocked or otherwise prevented from proceeding. In other implementations, an alert is provided to a user device 102 associated with the one or more service dependencies 120 that are out of parity (e.g., based on parity drift status information 130). For instance, the parity drift status of the one or more service dependencies 120 causes the ratio-based outage risk score 405, the affinity-based outage risk score, and/or the potential outage risk level indicator 410 to satisfy the upper threshold. In some examples, the alert includes a response link that a recipient can select to indicate a change in parity drift status of the corresponding service dependency 120.

In some implementations, the method 500 returns to operation 508, where updated parity drift status information 130 is received and, in some examples, an updated ratio-based outage risk score 405, the affinity-based outage risk score, and/or the potential outage risk level indicator 410 is determined based on the updated parity drift status information 130. In some examples, the outage projection system 125 receives an indication of a change in parity drift status of the one or more service dependencies 120. In some examples, the indication is received in response to a selection of the response link by the recipient of the alert. In other examples, the indication is received in response to a probe (e.g., monitoring performed) by the outage projection system 125. For instance, the outage projection system 125 monitors the parity drift status of the one or more service dependencies 120 and identifies when parity drift status information 130 of the one or more service dependencies 120 indicates the one or more service dependencies 120 are in parity or otherwise cause the outage risk score and/or level of the service of interest 110 to lower (e.g., reduce the risk of a service outage of the service of interest 110). When the ratio-based outage risk score 405, the affinity-based outage risk score, and/or the potential outage risk level indicator 410 are reduced such that the upper level is not satisfied (e.g., indicating a lower risk of a potential service outage), the method 500 continues to operation 520, where the configuration change of the service of interest 110 is triggered or otherwise authorized to proceed.

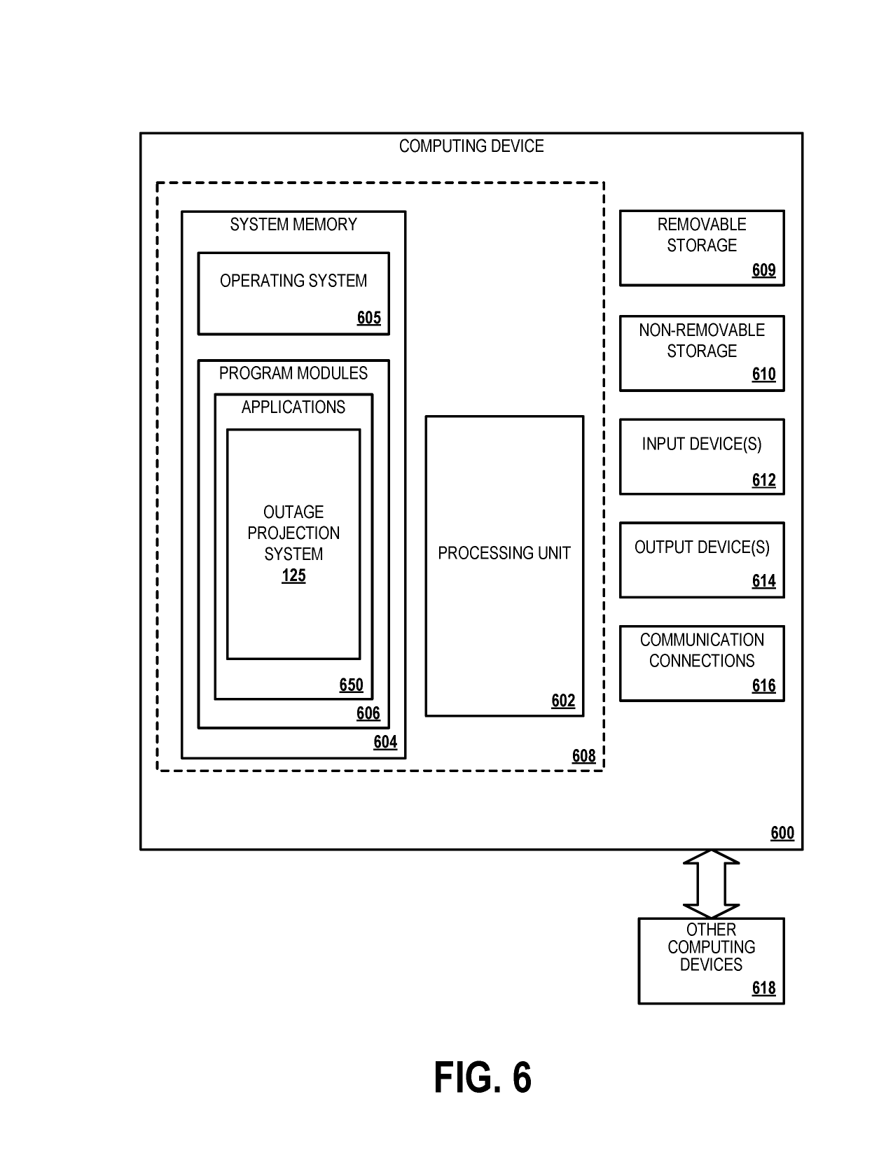

FIG. 6 and the associated description provide a discussion of a variety of operating environments in which examples of the invention may be practiced. However, the devices and systems illustrated and discussed with respect to FIG. 6 is for purposes of example and illustration and is not limiting of a vast number of computing device configurations that may be utilized for practicing aspects of the invention, described herein. FIG. 6 is a block diagram illustrating physical components (i.e., hardware) of a computing device 600 with which examples of the present disclosure may be practiced. In a basic configuration, the computing device 600 may include at least one processing unit and a system memory 604. in examples, the processing unit(s) (e.g., processors) are referred to as a processing system 602. Depending on the configuration and type of computing device, the system memory 604 may comprise volatile storage (e.g., random access memory), non-volatile storage (e.g., read-only memory), flash memory, or any combination of such memories. The system memory 604 may include an operating system 605 and one or more program modules 606 suitable for running software applications 650 (e.g., outage projection system 125).

The operating system 605, for example, may be suitable for controlling the operation of the computing device 600. Furthermore, aspects of the invention may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing system 602, the program modules 606 may perform processes including one or more of the operations of the method 500 illustrated in FIG. 5. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 600 on the single integrated circuit (chip). Examples of the present disclosure may also be practiced using other technologies capable of performing logical operations such as, for example, AND, OR, and NOT, including mechanical, optical, fluidic, and quantum technologies.

The computing device 600 may also have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, radio frequency (RF), infrared, and other wireless media.

According to an aspect, a method is provided, comprising: identifying a first service in a cloud computing system; identifying a second service in the cloud computing system, where the first service is dependent on the second service; receiving parity drift status information of the second service in the cloud computing system; determining a first outage risk score for the first service in the cloud computing system based on the parity drift status information of the second service; providing an indication of the first outage risk score for the first service in the cloud computing system; providing an alert corresponding to the second service being out of parity when the parity drift status information of the second service indicates the second service is out of parity and the first outage risk score satisfies an upper threshold; and triggering a configuration change of the first service when the first outage risk score satisfies a lower threshold.

According to an aspect, a computer system is provided comprising: a processing system; and memory comprising computer program instructions for performing operations comprising: identifying a service of interest in a first cloud computing system; identifying a service dependency of the service of interest in the first cloud computing system; receiving parity drift status information of the service dependency in the first cloud computing system; determining a first outage risk score for the service of interest in the first cloud computing system based on the parity drift status information of the service dependency; and providing an indication of the first outage risk score for the service of interest in the first cloud computing system.

According to an aspect, a method is provided, comprising: identifying a first service in a first cloud computing system; identifying a second service in the first cloud computing system, wherein: the second service is a service dependency of the first service; and the second service comprises a plurality of service dependencies of the first service; receiving parity drift status information of the second service in the first cloud computing system; determining an outage risk score for the first service in the first cloud computing system based on identifying a correlation between a pattern of the parity drift status information of the second service and a pattern of historical parity drift status information corresponding to a past outage of the first service; and providing an indication of the outage risk score for the first service in the first cloud computing system.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A method, comprising:
identifying a first service in a cloud computing system;
identifying a second service in the cloud computing system, where the first service is dependent on the second service;
receiving parity drift status information of the second service in the cloud computing system;
determining a first outage risk score for the first service in the cloud computing system based on the parity drift status information of the second service;
providing an indication of the first outage risk score for the first service in the cloud computing system;
providing an alert corresponding to the second service being out of parity when the parity drift status information of the second service indicates the second service is out of parity and the first outage risk score satisfies an upper threshold; and
triggering a configuration change of the first service when the first outage risk score satisfies a lower threshold.

2. The method of claim 1, further comprising:
determining a second outage risk score for the first service in the cloud computing system based on identifying a correlation between a pattern of the parity drift status information of the second service and a pattern of historical parity drift status information corresponding to a past outage of the first service; and
providing an indication of the second outage risk score for the first service in the cloud computing system.

3. The method of claim 2, wherein the second service comprises a plurality of service dependencies of the first service.

4. The method of claim 2, wherein determining the second outage risk score comprises:
inputting the parity drift status information of the second service into an outage projection model;
detecting the pattern of the parity drift status information of the second service using the outage projection model;
correlating the pattern of the parity drift status information of the second service to the pattern of historical parity drift status information corresponding to the past outage of the first service using the outage projection model;
calculating the second outage risk score based on the correlation using the outage projection model; and
outputting the second outage risk score from the outage projection model.

5. The method of claim 4, wherein calculating the second outage risk score comprises applying at least one of:
a severity weight based on a severity level of the past outage of the first service; or
a frequency weight based on a number of occurrences of the past outage of the first service.

6. The method of claim 4, further comprising:
receiving service outage information associated with the past outage of the first service;
receiving the historical parity drift status information corresponding to the past outage of the first service; and
configuring the outage projection model to:
detect the pattern of the parity drift status information of the second service;
correlate the pattern of the parity drift status information of the second service to the pattern of historical parity drift status information corresponding to the past outage of the first service; and
calculate the second outage risk score based on the correlation.

7. The method of claim 2, further comprising:
determining an outage risk level based on the second outage risk score; and
providing an indication of the outage risk level.

8. A system, comprising:
a processing system; and
memory storing instructions that, when executed, cause the system to perform operations comprising:
identifying a service of interest in a first cloud computing system;
identifying a service dependency of the service of interest in the first cloud computing system;
receiving parity drift status information of the service dependency in the first cloud computing system;
determining a first outage risk score for the service of interest in the first cloud computing system based on the parity drift status information of the service dependency; and
providing an indication of the first outage risk score for the service of interest in the first cloud computing system.

9. The system of claim 8, further comprising:
determining a second outage risk score for the service of interest in the first cloud computing system based on identifying a correlation between a pattern of the parity drift status information of the service dependency in the first cloud computing system and a pattern of historical parity drift status information corresponding to a past outage of the service of interest; and
providing an indication of the second outage risk score for the service of interest in the first cloud computing system.

10. The system of claim 9, wherein:
the system further comprises an outage projection model; and
determining the second outage risk score comprises:
inputting the parity drift status information of the service dependency into the outage projection model;
detecting the pattern of the parity drift status information of the service dependency using the outage projection model;
correlating the pattern of the parity drift status information of the service dependency to the pattern of historical parity drift status information corresponding to the past outage of the service of interest using the outage projection model;
calculating the second outage risk score based on the correlation using the outage projection model; and
outputting the second outage risk score from the outage projection model.

11. The system of claim 10, further comprising:
receiving service outage information associated with the past outage of the service of interest;
receiving the historical parity drift status information corresponding to the past outage of the service of interest; and
training the outage projection model to:
detect the pattern of the parity drift status information of the service dependency;
correlate the pattern of the parity drift status information of the service dependency to the pattern of historical parity drift status information corresponding to the past outage of the service of interest; and
calculate the second outage risk score based on the correlation.

12. The system of claim 11, further comprising providing an alert corresponding to the service dependency being out of parity when the parity drift status information of the service dependency indicates the service dependency is out of parity and the first outage risk score or the second outage risk score satisfies an upper threshold.

13. The system of claim 11, further comprising triggering a configuration change of the service of interest when the first outage risk score or the second outage risk score satisfies a lower threshold.

14. The system of claim 11, further comprising:
receiving parity drift status information of the service dependency in a second cloud computing system;
determining a third outage risk score for the service of interest in the second cloud computing system based on identifying a correlation between a pattern of the parity drift status information of the service dependency in the second cloud computing system and a pattern of historical parity drift status information corresponding to a past outage of the service of interest; and
providing an indication of the third outage risk score for the service of interest for the second cloud computing system.

15. The system of claim 9, wherein providing the indication of the second outage risk score comprises providing the indication of the second outage risk score to a deployment orchestration system.

16. A method, comprising:
identifying a first service in a first cloud computing system;
identifying a second service in the first cloud computing system, wherein:
the second service is a service dependency of the first service; and
the second service comprises a plurality of service dependencies of the first service;
receiving parity drift status information of the second service in the first cloud computing system;
determining an outage risk score for the first service in the first cloud computing system based on identifying a correlation between a pattern of the parity drift status information of the second service and a pattern of historical parity drift status information corresponding to a past outage of the first service; and
providing an indication of the outage risk score for the first service in the first cloud computing system.

17. The method of claim 16, further comprising providing an alert corresponding to the second service being out of parity when the parity drift status information of the second service indicates the second service is out of parity and the outage risk score satisfies an upper threshold.

18. The method of claim 16, further comprising triggering a configuration change of the first service when the outage risk score satisfies a lower threshold.

19. The method of claim 16, wherein determining the outage risk score comprises:
receiving service outage information associated with the past outage of the first service;
receiving the historical parity drift status information corresponding to the past outage of the first service; and
training a machine learning model to:
detect the pattern of the parity drift status information of the second service;
correlate the pattern of the parity drift status information of the second service to the pattern of historical parity drift status information corresponding to the past outage of the first service; and
calculate the outage risk score based on the correlation;
inputting the parity drift status information of the second service in the first cloud computing system into the machine learning model;
detecting the pattern of the parity drift status information of the second service in the first cloud computing system using the machine learning model;
correlating the pattern of the parity drift status information of the second service in the first cloud computing system to the pattern of historical parity drift status information corresponding to the past outage of the first service using the machine learning model;
calculating the outage risk score based on the correlation using the machine learning model, wherein calculating the outage risk score comprises applying at least one of:
a severity weight based on a severity level of the past outage of the first service; or
a frequency weight based on a number of occurrences of the past outage of the first service; and
outputting the outage risk score from the machine learning model.

20. The method of claim 16, further comprising:
receiving parity drift status information of the second service in a second cloud computing system;
determining a second outage risk score for the first service for the second cloud computing system based on identifying a correlation between a pattern of the parity drift status information of the second service in the second cloud computing system and a pattern of historical parity drift status information corresponding to a past outage of the first service; and
providing an indication of the second outage risk score for the first service in the second cloud computing system.
